(19) United States
(12) Patent Application Publication
(10) Pub. No.: US 2022/0315841 A1
(43) Pub. Date: Oct. 6, 2022

(54) EXTRACTION SOLVENTS FOR PLASTIC-DERIVED SYNTHETIC FEEDSTOCK

(71) Applicant: ECOLAB USA INC., St. Paul, MN (US)

(72) Inventors: Theodore C. Arnst, Sugar Land, TX (US); Karina Eureste, Houston, TX (US); Kameswara Vyakaranam, Sugar Land, TX (US); Tannon S. Woodson, Houston, TX (US); John N. Scholz, Sugar Land, TX (US)

(73) Assignee: ECOLAB USA INC., St. Paul, MN (US)

(21) Appl. No.: 17/708,642

(22) Filed: Mar. 30, 2022

Related U.S. Application Data
(60) Provisional application No. 63/168,643, filed on Mar. 31, 2021.

(51) Int. Cl. C10G 1/00; B01D 11/02; C10G 1/02

(52) U.S. Cl. CPC C10G 1/002; B01D 11/0288; B01D 11/0284; C10G 1/02; C10G 2300/1003

(57) ABSTRACT

Disclosed are extraction solvents used in compositions and methods to refine synthetic feedstocks derived from plastic. Methods of refining plastic-derived synthetic feedstocks are also provided. For example, a method of refining a plastic-derived synthetic feedstock composition may include adding an extraction solvent to a synthetic feedstock composition derived from plastic pyrolyis to provide an extract phase and a raffinate phase, wherein the extraction solvent includes a polar organic extraction solvent immiscible in the synthetic feedstock. The methods may also include separating the raffinate phase from the extract phase to obtain a refined synthetic feedstock.

### FIELD OF APPLICATION

The application is directed at inhibiting or reducing fouling during the production of synthetic feedstock derived from plastics.

### BACKGROUND

Post-consumer plastic and off-specification plastic materials can be chemically recycled by heating these plastic materials in a pyrolysis reactor, which breaks the polymer chains into smaller, volatile fragments. The vapors from the reactor are condensed and recovered as pyrolysate or pyrolysis oil, while the smaller, non-condensable hydrocarbon fragments are recovered as fuel gas.

During recovery of the pyrolysate, foulants such as black or brown, tar-like substances, which are insoluble in the pyrolysis oil, accumulate and foul the process equipment, such as distillation towers, pumps, process piping, filters, and the like. The deposition of foulant, which accumulates over time, eventually requires shutdown of the equipment for cleaning.

When pyrolysis oil (pyrolysate) is stored for extended periods of time, the storage containers can also accumulate a foulant, such as a brown film. This brown film forms with or without the presence of air. The film formation is accelerated by increased temperature, but can form at room temperature over longer time periods (e.g., seven days).

### BRIEF SUMMARY

Described herein are compositions and methods for extracting foulants from pyrolysis oil obtained from plastic.

In one aspect, the disclosure provides a method of refining a plastic-derived synthetic feedstock composition, comprising:
adding an extraction solvent to a synthetic feedstock composition derived from plastic pyrolyis to provide an extract phase and a raffinate phase, wherein the extraction solvent comprises a polar organic extraction solvent immiscible in the synthetic feedstock; and
separating the raffinate phase from the extract phase to obtain a refined synthetic feedstock.

In another aspect, the present disclosure provides a composition comprising a synthetic feedstock derived from plastic, wherein the synthetic feedstock is obtained by the method of
(a) heating plastic under substantially oxygen free conditions at a temperature from about 400° C. to about 850° C. to produce a pyrolysis effluent; and
(b) cooling and condensing the pyrolysis effluent to obtain a synthetic feedstock;
(c) recovering the synthetic feedstock;
(d) adding an extraction solvent to the synthetic feedstock composition to provide an extract phase and a raffinate phase, wherein the extraction solvent comprises a polar organic extraction solvent immiscible in the synthetic feedstock; and
(e) separating the raffinate phase from the extract phase to obtain a refined synthetic feedstock.

In still another aspect, the disclosure provides the use of the extraction solvent to reduce contamination or foulant in synthetic feedstocks derived from plastics.

The disclosed compositions and methods reduce or eliminate foulants in synthetic feedstock providing higher quality feedstock materials and reducing cost and time for system and equipment cleaning.

### BRIEF DESCRIPTION OF DRAWINGS

FIG. 1 is a schematic representation of an embodiment of a plastic pyrolysis process.

FIG. 2 is a schematic representation of an embodiment of a plastic pyrolysis process.

FIG. 3 is a schematic representation of an embodiment of a plastic pyrolysis process showing treatment with extraction solvent.

FIG. 4 is a schematic representation of an embodiment of a plastic pyrolysis process showing treatment with extraction solvent.

FIG. 5 is a schematic representation of an embodiment of a plastic pyrolysis process showing treatment with extraction solvent.

FIGS. 6A and 6B shows infrared spectra for different film-foulant containing samples.

FIG. 7 is a bar graph of the desorption products for various films obtained after storage at various temperatures. The film-foulant samples are designated as follows: NE00632=Blank pyrolysate without nitrogen @ 25° C.; NE00633=Blank pyrolysate with nitrogen @ 25° C.; NE00634=Blank without nitrogen @ 43° C.; NE00635=Blank with nitrogen @ 43° C.; NE00636=Blank pyrolysate without nitrogen @ 75° C.; NE00637=Blank with nitrogen @ 75° C.

### DETAILED DESCRIPTION

Although the present disclosure provides references to various embodiments, persons skilled in the art will recognize that changes may be made in form and detail without departing from the spirit and scope of the application. Various embodiments will be described in detail with reference to the figures. Reference to various embodiments does not limit the scope of the claims attached hereto. Additionally, any examples set forth in this application are not intended to be limiting and merely set forth some of the many possible embodiments for the appended claims.

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present application. All publications, patent applications, patents and other references mentioned herein are incorporated by reference in their entirety.

As used herein, the term “extract phase” means an organic liquid that is immiscible with the synthetic feedstock and has a stronger affinity for the foulants and foulant precursors.

As used herein, the term “foulant” means organic and inorganic materials that deposit on equipment during the operation and manufacturing of synthetic feedstock or accumulate during storage.

As used herein, the term “process equipment” means distillation towers, pumps, process piping, filters, condensers, quench towers, storage equipment, and the like, which are associated with the process and which may be subject to fouling. This term also includes sets of components which are in fluidic or gas communication.

As used herein, the term “raffinate phase” refers to the phase that includes the refined synthethic feedstock.

The term “synthetic feedstock” refers to hydrocarbons obtained from treatment or processes on plastics such as thermochemical conversion of plastics (e.g., pyrolysis oil or pyrolysate).

As used herein, the terms “comprise(s),” “include(s),” “having,” “has,” “can,” “contain(s),” and variants thereof are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments, steps, and/or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5” and “about 1 to about 5” and “1 to about 5” and “about 1 to 5” unless specifically limited by context.

As used herein, the term “substantially” means “consisting essentially of” and includes “consisting of” “Consisting essentially of” and “consisting of” are construed as in U.S. patent law. For example, a solution that is “substantially free” of a specified compound or material may be free of that compound or material, or may have a minor amount of that compound or material present, such as through unintended contamination, side reactions, or incomplete purification. A “minor amount” may be a trace, an unmeasurable amount, an amount that does not interfere with a value or property, or some other amount as provided in context. A composition that has “substantially only” a provided list of components may consist of only those components, or have a trace amount of some other component present, or have one or more additional components that do not materially affect the properties of the composition. Additionally, “substantially” modifying, for example, the type or quantity of an ingredient in a composition, a property, a measurable quantity, a method, a value, or a range, employed in describing the embodiments of the disclosure, refers to a variation that does not affect the overall recited composition, property, quantity, method, value, or range thereof in a manner that negates an intended composition, property, quantity, method, value, or range. Where modified by the term “substantially” the claims appended hereto include equivalents according to this definition.

As used herein, any recited ranges of values contemplate all values within the range and are to be construed as support for claims reciting any sub-ranges having endpoints which are real number values within the recited range. By way of example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

Described are compositions and methods that refine synthetic feedstocks derived from plastics. Refined synthetic feedstocks therefore have reduced fouling of equipment and systems used in plastic recycling and during storage.

In some embodiments, a method for refining pyrolysis oil includes adding to the pyrolysis oil an extraction solvent. The extraction solvent extracts the foulant and produces a refined synthetic feedstock.

In some embodiments, the extraction solvent is added to the synthetic feeds to provide a mixture that forms an extract phase and a raffinate phase. The extract phase contains the foulant and raffinate phase contains a more refined synthetic feedstock. In some embodiments, the extraction solvent is a polar organic solvent, and the synthetic feedstock is derived from the pyrolysis of plastic.

Various plastic types, such a thermoplastic waste, can be used to recycle plastics. The types of plastics commonly encountered in waste-plastic feedstock include, without limitation, low-density polyethylene, high-density polyethylene, polypropylene, polystyrene and the like, and combinations thereof. In some embodiments, the synthetic feedstock comprises pyrolysis of plastic comprising polyethylene, polypropylene, polystyrene, polyethylene terephthalate and combinations thereof. In some embodiments, while polyethylene, polypropylene and lesser amounts of polystyrene are present, polyvinylchloride and polyethylene terephthalate are present due to sorting difficulties.

Several processes are known in which plastic (e.g., waste plastic) is converted to lower molecular weight hydrocarbon materials, particularly to hydrocarbon fuel materials. For example, see U.S. Pat. Nos. 6,150,577; 9,200,207; and 9,624,439; each of these publications are incorporated herein by reference in their entireties. Such processes broadly described include breaking the long-chain plastic polymers by thermochemical conversion, such as pyrolysis—high heat (e.g., from 400° C.-850° C.) with limited or no oxygen and above atmospheric pressure. Pyrolysis conditions include a temperature from about 400° C.-850° C., from about 500 ° C. — 700° C., or from about 600° C. — 700° C. The resultant pyrolysis effluent is condensed and then optionally distilled.

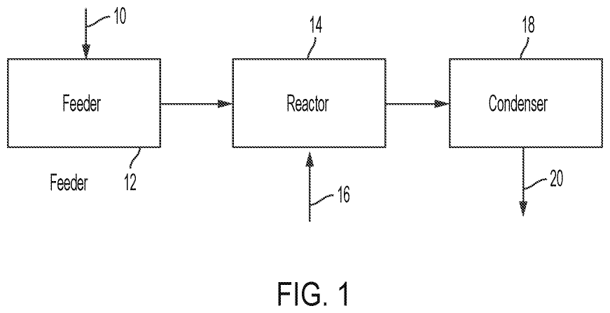

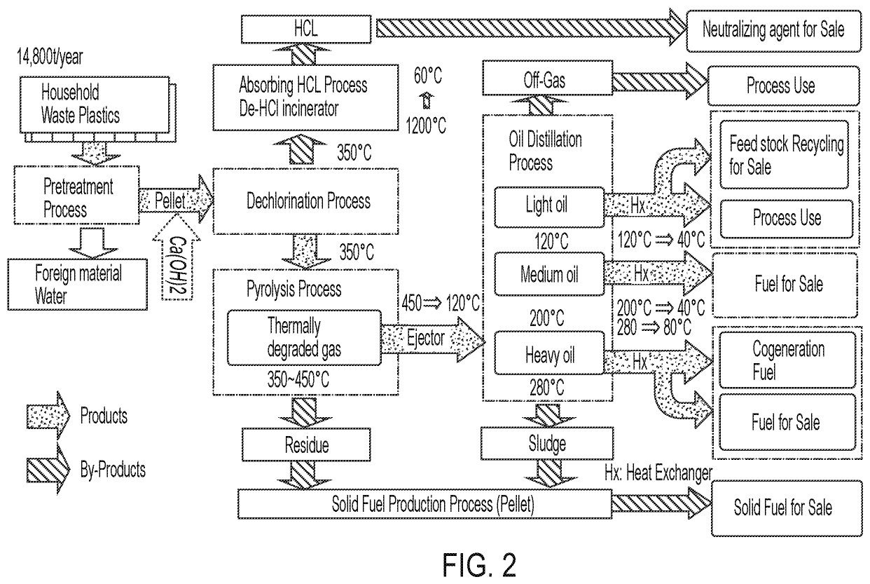

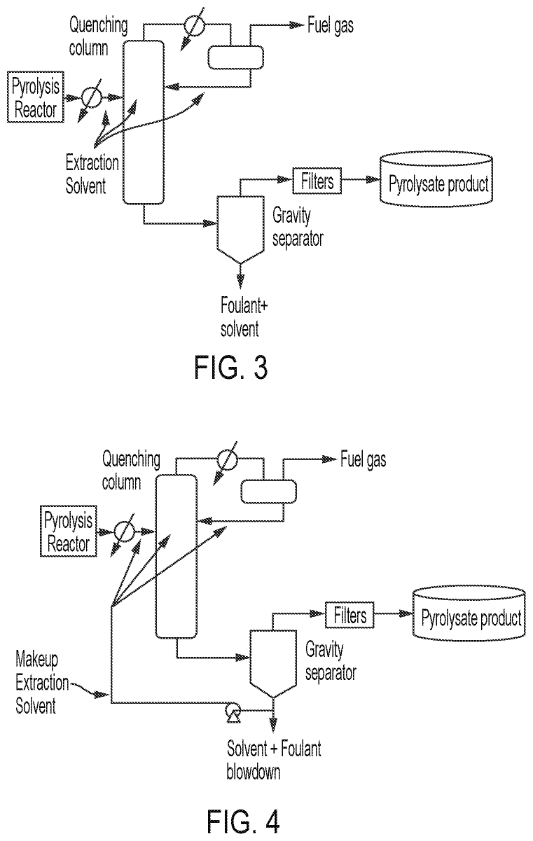

As shown in FIG. 1, an embodiment of a pyrolysis process includes a feeder 12 of waste plastic, a reactor 14, and a condenser system 18. Polymer-containing material is fed through inlet 10 in the feeder, and heat is applied to reactor 14. An outlet 20 from condenser system 18 allows for the product to exit. FIG. 2 depicts another embodiment of a pyrolysis process for plastic. FIGS. 3 and 4 depict yet other embodiments showing the process after the condensing or quenching of the pyrolysis effluent. The thermal cracking reactors to accomplish this pyrolysis reaction have been described in detail in a number of patents, e.g., U.S. Pat. Nos. 9,624,439; 10,131,847; 10,208,253; and PCT International Pat. Appl. Pub. No. WO 2013/123377A1, each of these publications is incorporated herein by reference in their entireties.

In some embodiments, the method of obtaining the synthetic feedstock is in the presence or absence of catalysts.

In some embodiments, the method of obtaining the synthetic feedstock comprises:
(a) heating plastic under substantially oxygen free conditions at a temperature from about 400° C. to about 850° C. to produce a pyrolysis effluent;
(b) cooling and condensing the pyrolysis effluent to obtain a synthetic feedstock; and
(c) recovering the synthetic feedstock.

In some embodiments, after cooling and condensing, the effluent is optionally distilled.

In some embodiments, recovering synthetic feedstock relates to separating or quenching or both separating and quenching the pyrolysis effluent to obtain the synthetic feedstock.

The pyrolysis process produces a range of hydrocarbon products from gases (at temperatures from 10° C. to 50° C. and 0.5-1.5 atmospheric pressure and having 5 carbons or less); modest boiling point liquids (like gasoline or naptha (40-200° C.) or diesel fuel (180-360° C.); a higher (e.g., at 250-475° C.) boiling point liquid (oils and waxes), and some solid residues, commonly referred to as char. Char is the material that is left once the pyrolytic process is complete and the reactor effluent is recovered. Char contains the additives and contaminants that enter the system as part of the feedstock. The char can be a powdery residue or substance that is more like sludge with a heavy oil component. Glass, metal, calcium carbonate/oxide, clay and carbon black are just a few of the contaminants and additives that will remain after the conversion process is complete and become part of the char.

In some embodiments, the pyrolysis of plastic results in synthetic feedstocks (e.g., pyrolysate or pyrolysis oil) that include about 2-30% gas (C₁-C₄ hydrocarbon); (2) about 10-50% oil (C₅-C₁₅ hydrocarbon); (3) about 10-40% waxes (≥C₁₆ hydrocarbon); and (4) about 1-5% char.

The hydrocarbons that derive from the pyrolysis of waste plastic are a mixture of alkanes, alkenes, olefins and diolefins; the olefin group is generally between C₁ and C₂, viz. alpha-olefin, some alk-2-ene is also produced; the diene is generally in the alpha and omega position, viz. alk-α,ω-diene. In some embodiments, the pyrolysis of plastic produces paraffin compounds, isoparaffins, olefins, diolefins, naphthenes and aromatics. In some embodiments, the percentage of 1-olefins in the pyrolysis effluent is from about 25 to 75 wt. %; or from about 35 to 65 wt %.

Depending on the processing conditions synthetic feedstock can have characteristics similar to crude oil from petroleum sources but may have varying amounts of olefins and diolefins. In some embodiments, the synthetic feedstock derived from waste plastic contains about 35-65% olefins and/or diolefins, about 10-50% paraffins and/or iso-paraffins, about 5-25% naphthenes, and about 5-35% aromatics. In some embodiments, the synthetic feedstocks have carbon lengths of about 15-20 wt. % C₉-C₁₆; about 75-87 wt. % C₁₆-C₂₉; about 2-5% C₃₀₊, where the carbon chains are predominantly a mixture of alkanes, alkenes and diolefins. In other embodiments, the synthetic feedstocks have about 10 wt. %<C₁₂, about 25 wt. % C₁₂-C₂₀, about 30 wt. % C₂₁-C₄₀ and about 35 wt. %>C₄₁ where the carbon chains are predominantly a mixture of alkanes, alkenes and diolefins. In still other embodiments, the synthetic feedstocks have about 60-80 wt. % C₅-C₁₅, about 20-35 wt. % C₁₆-C₂₉, and about 5 wt. % or less≥C₃₀, where the carbon chains are predominantly a mixture of alkanes, alkenes and diolefins. In some embodiments, the synthetic feedstocks have about 70-80 wt. % C₅-C₁₅ and about 20-35 wt. % C₁₆-C₂₉ where the carbon chains are predominantly a mixture of alkanes, alkenes and diolefins.

In some embodiments, the synthetic feedstock composition has a range of alpha or omega olefin monomer constituents (e.g., alpha olefin or alpha, omega diolefin) which can react and precipitate from the synthetic feedstock composition at a temperature greater than its desired temperature or during storage, transport, or use temperature. In some embodiments the synthetic feedstocks is about 25-70 wt. % olefins and/or diolefins or about 35-65 wt. %, about 35-60 wt. % or about 5-50 wt. % olefins and/or diolefins.

When pyrolysis oil (pyrolysate) is stored for extended periods of time, the storage container begins to accumulate a brown film. This brown film forms with or without the presence of air (oxygen). The film formation is accelerated by increased temperature, but it will form at room temperature over week-long periods of time. Analysis of this brown film by infrared spectroscopy shows that this is a similar composition as the tar-like substance that fouls the pyrolysate recovery equipment.

In some embodiments, the foulant in the synthetic feedstock is a “tar” like deposit or is a brown film like foulant and combinations thereof. In some embodiments, the “tar” like deposit is a solid viscoelastic substance, and a dark brown or black viscous liquid, which each result from the pyrolysis of impure waste plastic. In some embodiments, the “tar” like deposit is a suspension of tiny black particles in dark brown or black viscous liquid, which has the consistency of soft artist modeling clay. In some embodiments the solids and the dark viscous liquid possess the same infrared spectroscopic characteristics.

In some embodiments, the foulant (e.g., as a solid viscoelastic substance) includes polyamides with additional carboxylic acid and hydroxyl functional groups and has an elemental composition of about 62-75% carbon, about 6-9% hydrogen, about 3-7% nitrogen and about 12-25% oxygen. In some embodiments, the elemental composition of the foulant is about 62-75% carbon, about 6-9% hydrogen, about 3-7% nitrogen, about 12-25% oxygen and less than about 0.3% sulfur.

In some embodiments, the foulant present in the pyrolysis oil is a secondary amide, which also contains hydroxyl and carbonyl functional groups beyond those associated with the amide functional group. In some embodiments, the foulant is a polyamide, with long chain aliphatic groups, carboxylic acid groups, amide groups, aromatic groups with minor amounts of olefinic unsaturation and combinations thereof. In some embodiments, the foulant is a polyamide, with long chain aliphatic groups, carboxylic acid groups, amide groups, aromatic groups with olefinic unsaturation, alkenes, alkanes, benzoic acid, caprolactum, toluene, xylene, cresol, phenol, isopropylphenol, tert-butylphenol and di-tert butyl phenol, dimethylphenol, napthalenol, varying lengths of alkenes and alkanes and combinations thereof.

Heating of the sample at about 600° C. thermally decomposes the sample into various fragments. The major fragments identified were propylene, tolune, caprolactam, pentene and butane. Minor fragments included tetramethylindole, ethylbenzene, ethyldimethylpyrorole, dimethylfuran, and tetrahydroquinoline.

In some embodiments, the foulant comprises a metal, a heteroatom, and/or other unwanted byproducts in the pyrolysis oil.

In some embodiments, the extraction solvent is capable of extracting, removing or reducing the foulant concentration in the pyrolysis oil. In some embodiments, the foulant is soluble in the extraction solvent and the extraction solvent is insoluble in the pyrolysis oil. In some embodiments, the extraction solvent is a polar extraction solvent that is insoluble in the pyrolysis oil, and the combination of extraction solvent and foulant has a density different from the pyrolysis oils. Having a different density enhances the separation (e.g., gravimetric separation) of the foulant and extraction solvent from the pyrolysis oil. The extraction solvents are denser than the pyrolysate product, as is the pyrolysate foulant, which gravimetrically increases the contact efficiency between the extraction solvent and the foulant; where the foulant has a tendency to settle in the process equipment and the added extraction solvent would settle to the same places. The high density of the foulant/extraction solvent mixture allows for use of bleeder drains or settling drums to remove the foulant from the pyrolysate product.

In some embodiments, the extraction solvents have a polarity of about 2.5 to about 3.5 Debyes, a specific density of about 1.1 to about 1.2 relative to water at about 20° C., and a boiling point greater than or equal to about 200° C., such as from about 200° C. to about 350° C.

In some embodiments, the extraction solvent is diethylene glycol, triethylene glycol, diethylene glycol monobutyl ether, ethylene glycol monobutyl ether, acetone, N-methyl pyrrolidone (NMP), isopropyl alcohol, diethylene triamine, tetraethylene glycol, glycol heavies and combinations thereof. Ethylene glycol and water were found to be ineffective as extraction solvents for the foulants. In some embodiments, the extraction solvent is diethylene glycol, triethylene glycol, tetraethylene glycol, glycol heavies or combinations thereof In some embodiments, the glycol heavies is the bottom stream after distillative recovery of ethylene glycol.

The extraction solvents are useful in preventing or reducing deposition of foulant in process equipment, such as quench towers or columns used in synthetic feedstock production processes. In some embodiments, the extraction solvent is added during production of the synthetic feedstock, to feedstock held in storage (refined or unrefined) or combinations thereof. By extracting the foulant in the extract phase, the extraction solvents reduce the foulant, which leads to better quality feedstock. The extraction solvent may be added at one or more locations in the process.

In some embodiments, the extraction solvent is added at the point where the gaseous pyrolysate begins to condense and the extraction solvent is allowed to travel with the condensed pyrolysate and achieve contact with the foulant that has settled or would otherwise settle in the absence of extraction solvent (see FIG. 3, for example). In some embodiments, the two-phase mixture then flows into a settling drum where the extraction solvent and foulant are removed by gravity. In some embodiments, gravity settling is carried out with a hydrocyclone-type separator.

In another embodiment (see FIG. 4), the extraction solvent is applied as an initial batch dose into a gravity separator. The extraction solvent is then pumped from the separator bottom into the pyrolysate vapor recovery system and the extraction solvent is allowed to travel through the pyrolysate condensate recovery system and returned to the separator drum. The extraction solvent would cycle over and over until a nominal concentration of foulant had accumulated at which time a fraction of the foulant-laden extraction solvent could be removed and replenished with fresh extraction solvent; either in a batch or continuous manner.

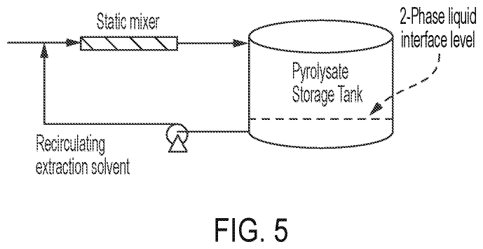

In some embodiments (see FIG. 5, for example), the extraction solvent is used for scrubbing or washing of the pyrolysate product that is held in storage. The extraction solvent and pyrolysate product would be intimately mixed via a static mixer or by introducing the extraction solvent to the pyrolysate just in front of a centrifugal pump, which would provide the mixing energy. The extraction solvent and pyrolysate would then travel together to an interim storage tank where the extraction solvent would separate by gravity from the pyrolysate product. The extraction solvent layer could then be recovered from the bottom of the tank and returned to the static mixer (or pump suction) until the concentration of reactive compounds reached a concentration that interferes with extraction efficiency, at which time a fraction of the circulating extraction solvent is removed and replenished with fresh extraction solvent.

In some embodiments, the extraction solvent is added at the inlet of a quenching tower, or a column, air-cooled, or water-cooled condenser when the synthetic feedstock vapor leaving a pyrolysis reactor is quenched and the gases are cooled and condensed at a temperature from about 100° C.-200° C., about 110° C.-140° C., or about 105° C. to 120° C. In some embodiments, the extraction solvent is added to a synthetic feedstock held in storage.

The extraction solvent may be added by any suitable method. For example, the extraction solvent may be added in neat or with an adjuvant. In some embodiments, the adjuvant is water or dispersants (e.g., surfactants). In some embodiments, the extraction solvent is about 90% NMP with about 10% water, or DEG/TEG with adjuvant, such as Pluronic L-64 or Pluronic L-61. In some embodiments, the extraction solvent may be applied as a solution that is sprayed, dripped or injected into a desired opening within a system or onto the process equipment or the fluid contained therein. In some embodiments, the extraction solvent can be pumped or injected into a system in a once through fashion or as a recirculation system with periodic purge and replacement. In some embodiments, the recirculating extraction solvent will have low volume continuous purge with matching replacement volume. The extraction solvent can be added continuously or intermittently to the process equipment as required.

The extraction solvent is applied to process equipment to form a treated process equipment. In some embodiments, treated process equipment can be observed to undergo less foulant deposition than process equipment without addition of the extraction solvent.

The extraction solvent can be added before in-process, during the process, post production, during storage (with or without an extraction with the extraction solvent) or any combinations thereof. In some embodiments, the mass ratio of synthetic feedstock (e.g., pyrolysis oil) to extraction solvent is about 95:5 to about 10:90. In some embodiments, the extraction solvent is added to the synthetic feedstock composition from about 1 ppm to about 900,000 ppm, such as from about 50,000 ppm to about 900,000 ppm, about 150,000 ppm to about 900,000 ppm, about 300,000 ppm to about 900,000 ppm, about 100 ppm to about 700,000 ppm, about 300 ppm to about 500,000 ppm, or about 500 ppm to about 250,000 ppm.

Reduction or prevention in the foulant formation or deposition can be evaluated by any known method or test, such as ASTM D4625. In some embodiments, the synthetic feedstocks treated with the extraction solvent have foulant contamination reduced by about 5% to 95%; about 5% to 75%; about 5% to 50%; about 5% to 25%; about 5% to 15%; about 50% to 95%; about 50% to 20%; or about 50% to 75%.

In some embodiments, color of the synthetic feedstock is lightened compared to synthetic feedstock without the addition of the extraction solvent.

Other additives can be added to the pyrolysis oil during the extraction and refinement process, at storage or to the refined pyrolysis oil. In some embodiments, the other additives are antioxidants, paraffin inhibitors, asphaltene dispersants, wax dispersants, tar dispersants, neutralizers, surfactants, biocides, preservatives, or any combination thereof. In some embodiments, the other additives are antioxidants, pour point depressants or both that are added to a refined pyrolysis. For example, antioxidants added include antioxidants reported in U.S. patent application Ser. No. 17/691,939 and pour point depressants reported in U.S. patent application Ser. No. 17/471,784. The reported applications are each incorporated herein by reference in their entireties.

In some embodiments, the refinement processes disclosed herein can be carried out in a pyrolysis oil and subsequently, the oil may be transported to a new location. Optionally, the refinement processes may be carried out once again at the new location.

The refinement processes disclosed herein allow for the production of pyrolysis oil having no (or substantially no) solids (film forming components) left in the oil after a certain period of time, such as while the oil is being stored. For example, the oil may be stored for about 30 days at a temperature between about room temperature and about 43° C. and after the storage time period, the oil does not comprise any solids or films. The extracted/refined oils disclosed herein are stable (contain no solids/films) at a variety of temperatures, such as about 25° C., 43° C., 75° C., or any temperature therebetween. The oils may be stored at temperatures up to about 150° C., for example, without forming any solids/films.

In some embodiments, a dispersant may be added to the refined oil to increase the amount of time an oil may be stored without forming any solids/films. For example, extractions may be carried out at one or more stages of production of the oil and a dispersant, such as a compound containing an olefin and/or anhydride, could be added before, during, or after any of the extractions.

### EXAMPLES

The following examples are intended to illustrate different aspects and embodiments of the invention and are not to be considered limiting the scope of the invention. It will be recognized that various modifications and changes may be made without departing from the scope of the claims.

### Example 1

### Foulant Characterizations

An elemental (CHNS) analysis was conducted on a sample of foulant film obtained from pyrolysis oil. The film was separated from the pyrolysis oil and washed with heptane and further dissolved in dichloromethane. The dichloromethane was evaporated leaving the foulant film.

Table 1 shows the CHNS analysis.

TABLE 1

| Element | Weight percent |
|---|---|
| Carbon | 63 |
| Hydrogen | 7.7 |
| Nitrogen | 6.8 |
| Sulfur | Less than 0.3 |
| Oxygen* | 22 |

*Oxygen by 100% minus sum of quantified elements

Foulant samples from different pyrolysis sources were also evaluated by infrared (IR) spectroscopy. The IR spectrum was evaluated using a Nicolet iS50 FTIR, equipped with an on-board diamond internal reflection accessory. The spectrum was run at four wavenumber resolution, and was the result of 32 co-added scans.

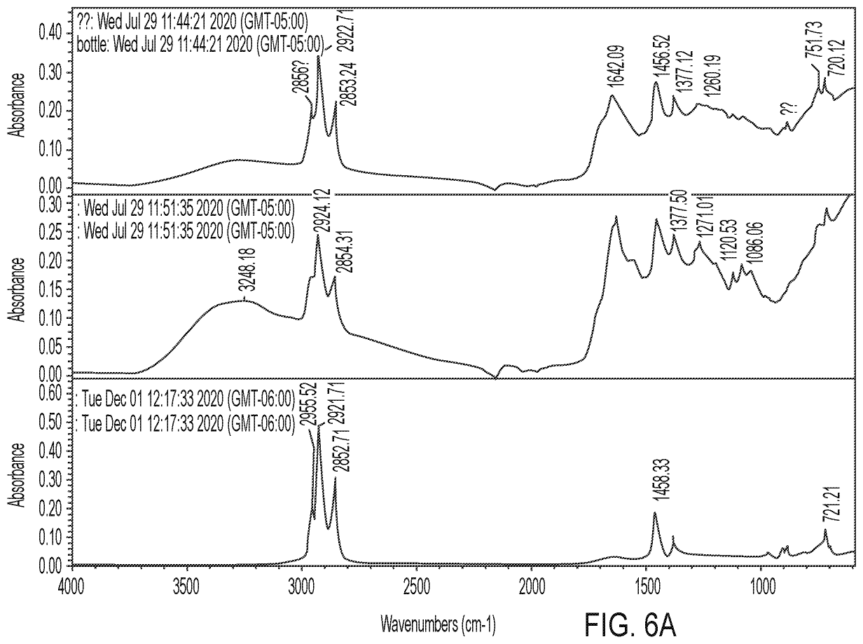

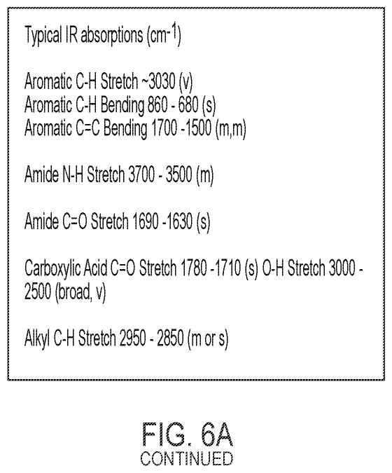

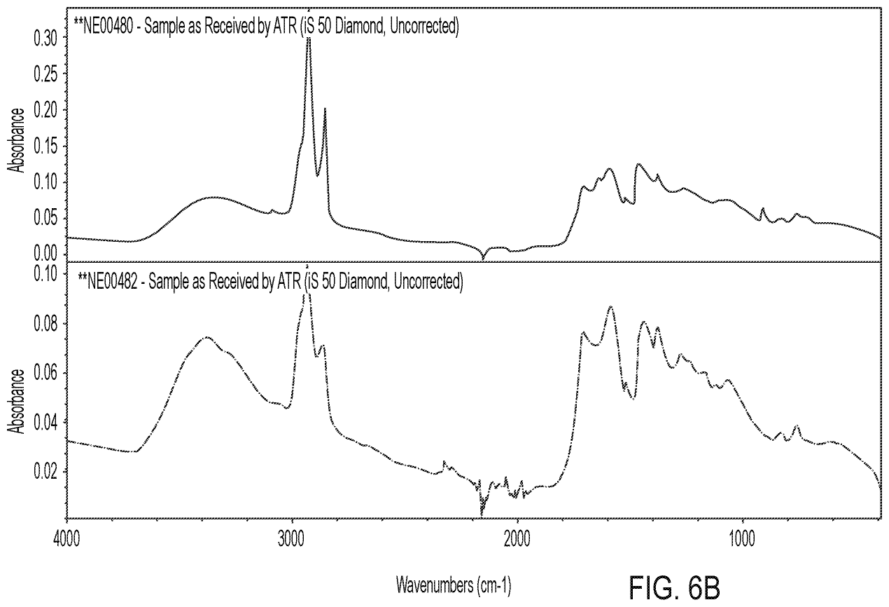

IR spectroscopy showed the presence of long chain aliphatic groups, carboxylic acid groups, amide groups, aromatic groups with minor amounts of olefinic unsaturation. The major component of the foulant was a secondary amide (e.g., polyamides). See FIG. 6, which shows that the foulants in the various samples showed similar compositions with some variation in the amounts of aliphatic hydrocarbons, carboxylic acids, amides, and aromatic compounds, among the group. The foulant composition within a sample showed similar compositions at different temperatures.

The thermal profiles of various pyrolysis samples from different sources were analyzed by Evolved Gas Analysis. The samples were heated at about 600° C. The volatile fraction of the samples were thermally desorbed from about 40° C. to about 300° C., chromatographically separated by gas chromatography, and detected by mass spectrometry.

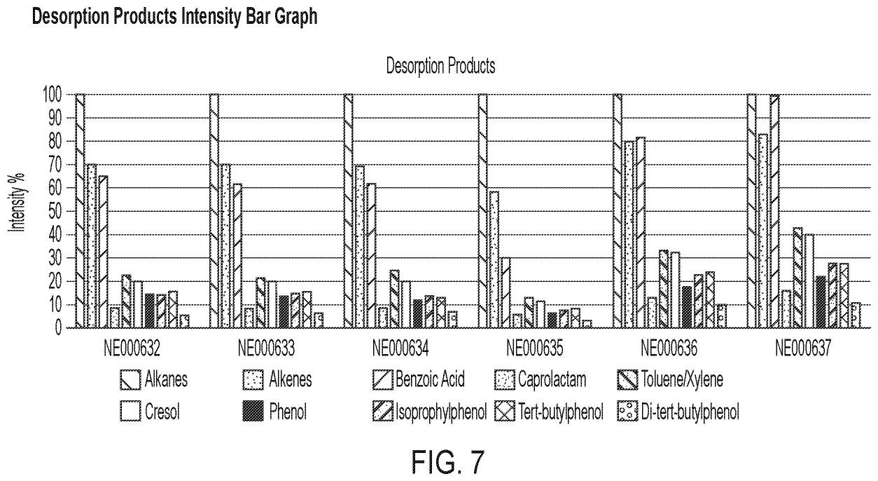

FIG. 7 shows the Evolved Gas Analysis and desorption products of foulant from pyrolysates. The volatile components identified showed a predominance of caprolactam with minor amounts of benzoic acid, phenol, p-cresol, dimethylphenol, isopropyl phenol, tert-butylphenol, dimethylethylphenol, napthalenol and varying lengths of alkenes and alkanes. Heating of the sample at about 600° C. thermally decomposes the sample into various fragments. The major fragments identified were propylene, tolune, caprolactam, pentene and butane. Minor fragments included tetramethylindole, ethylbenzene, ethyldimethylpyrrole, dimethylfuran, and tetrahydroquinoline.

### Example 2

### Extraction Solvents for Extraction of Foulants from Plastic Pyrolysis

The extraction of foulants from pyrolysis of plastic was evaluated by mixing at room temperature about 300 grams of pyrolysis feedstock with about 40 grams of diethylene glycol (reagent grade from Aldrich). After the layers separated and the first diethylene glycol extract phase was removed, a second wash with about 40 grams of diethylene glycol was performed on the remaining raffinate phase (viz., once already extracted sample) and again allowed to separate into layers where the extract phase was removed. The extraction of foulant was performed on pyrolysis feedstock sample 1 (about 60-80 wt. % C₅-C₁₅, about 20-35 wt. % C₁₆-C₂₉ and about 5 wt. % or less≥C₃₀) and pyrolysis feedstock sample 2 (about 70-80 wt. % C₅-C₁₅, about 20-35 wt. % C₁₆-C₂₉).

The washed feedstock was recovered and divided into several portions for stability testing at room temperature, about 43° C. and about 75° C. for about 30 days following ASTM D4625 procedural guidelines. Samples were observed for one month at elevated temperatures and 3 months at room temperature.

The results of the extraction showed that foulant film formation did not occur in the samples that had been extracted, but film formation was readily apparent in the untreated, unextracted samples. No film was formed after 30 days at room temperature and at about 43° C. for samples treated with diethylene glycol.

What is claimed is:

1. A method of refining a plastic-derived synthetic feedstock composition comprising:
adding an extraction solvent to a synthetic feedstock composition derived from plastic pyrolyis to provide an extract phase and a raffinate phase, wherein the extraction solvent comprises a polar organic extraction solvent immiscible in the synthetic feedstock; and
separating the raffinate phase from the extract phase to obtain a refined synthetic feedstock.

2. The method of claim 1, wherein the synthetic feedstock comprises a pyrolysis oil.

3. The method of claim 1, wherein the synthetic feedstock comprises about 60 to about 80 wt. % C₅-C₁₅, about 20 to about 35 wt. % C₁₆-C₂₉ and about 5 wt. % or less≥C₃₀.

4. The method of claim 1, wherein the extraction solvent comprises a polar organic extraction solvent with a polarity of about 2.5 to about 3.5 Debyes and a density of about 1.1 to about 1.2 relative to water at about 20° C., and a boiling point greater than or equal to about 200° C.

5. The method of claim 1, wherein the extraction solvent comprises diethylene glycol, triethylene glycol, diethylene glycol monobutyl ether, ethylene glycol monobutyl ether, acetone, isopropyl alcohol, diethylene triamine, tetraethylene glycol, glycol heavies, and any combination thereof.

6. The method of claim 1, wherein the extraction solvent comprises about 90 wt. % N-methyl pyrrolidone (NMP) and about 10 wt. % water.

7. The method of claim 1, wherein the mass ratio of synthetic feedstock to extraction solvent is about 95:5 to about 10:90.

8. The method of claim 1, wherein adding the extraction solvent is at an outlet of a quenching tower or at an air-cooled or water-cooled condenser after pyrolysis.

9. The method of claim 1, wherein adding the extraction solvent is after production of the pyrolysis oil, in a storage container, or any combination thereof.

10. The method of claim 1, wherein adding the extraction solvent is to the synthetic feedstock composition from about 1 ppm to about 900,000 ppm.

11. The method of claim 1, wherein the extract phase comprises a foulant.

12. The method of claim 11, wherein the foulant comprises a polyamide, caprolactam, benzoic acid, phenol, p-cresol, dimethylphenol, isopropyl phenol, tert-butylphenol, dimethylethylphenol, napthalenol, an alkene, an alkanes, propylene, tolune, pentene, butane, tetramethylindole, ethylbenzene, ethyldimethylpyrrole, dimethylfuran, tetrahydroquinoline, and any combination thereof.

13. The method of claim 1, wherein the synthetic feedstock composition further comprises an antioxidant, a pour point depressant, or any combination thereof

14. The method of claim 1, wherein the synthetic feedstock derived from plastic pyrolysis is obtained by:
(a) heating plastic under substantially oxygen free conditions at a temperature from about 400° C. to about 850° C. to produce a pyrolysis effluent;
(b) cooling and condensing the pyrolysis effluent to obtain a synthetic feedstock; and
(c) recovering the synthetic feedstock.

15. A composition comprising a synthetic feedstock derived from plastic, wherein the synthetic feedstock is obtained by:
(a) heating plastic under substantially oxygen free conditions at a temperature from about 400° C. to about 850° C. to produce a pyrolysis effluent;
(b) cooling and condensing the pyrolysis effluent to obtain a synthetic feedstock;
(c) recovering the synthetic feedstock;
(d) adding an extraction solvent to the synthetic feedstock to provide an extract phase and a raffinate phase, wherein the extraction solvent comprises a polar organic extraction solvent immiscible in the synthetic feedstock; and
(e) separating the raffinate phase from the extract phase to obtain a refined synthetic feedstock.

16. The composition of claim 15, wherein the synthetic feedstock comprises about 60 wt. % to about 80 wt. % C₅-C₁₅, about 20 wt. % to about 35 wt. % C₁₆-C₂₉ and about 5 wt. % or less≥C₃₀.

17. The composition of claim 15, wherein the extraction solvent comprises a polar organic extraction solvent with a polarity of about 2.5 to about 3.5 Debyes and a density of about 1.1 to about 1.2 relative to water at about 20° C., and a boiling point greater than or equal to about 200° C.

18. The composition of claim 15, wherein the extraction solvent comprises diethylene glycol, triethylene glycol, diethylene glycol monobutyl ether, ethylene glycol monobutyl ether, acetone, isopropyl alcohol, diethylene triamine, tetraethylene glycol, glycol heavies, and any combination thereof.

19. The composition of claim 15, wherein the raffinate phase comprises the refined synthetic feedstock.

20. The composition of claim 15, wherein the synthetic feedstock composition further comprises an antioxidant, a pour point depressant, a paraffin inhibitor, an asphaltene dispersant, a wax dispersant, a tar dispersant, a neutralizer, a surfactant, a biocide, a preservative, or any combination thereof.
